(19) United States
(12) Patent Application Publication
(10) Pub. No.: US 2007/0037557 A1
(43) Pub. Date: Feb. 15, 2007

(54) Method and system for multimedia messaging service

(76) Inventors: Xiaoling Shao, Shanghai (CN); Jiawen Tu, Shanghai (CN); Lei Feng, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/539,315

(22) PCT Filed: Dec. 17, 2003
(86) PCT No.: PCT/IB03/06023

§ 371 Date: Oct. 23, 2006

(30) Foreign Application Priority Data
Dec. 17, 2002 (CN) 02156191.5

(51) Int. Cl. H04Q 7/38

(52) U.S. Cl. 455/414.1; 455/466

(57) ABSTRACT

The invention allows a portion of a multimedia message, usually the beginning part of the message to be delivered to and stored on a mobile terminal beforehand. When a user wants to view the message, the portion of the message stored locally will be played back immediately, while at the same time a user agent residing in the mobile terminal will contact a media server for the remaining contents using the streaming technology. This would give the user an impression that the whole message is stored locally since there is nearly no noticeable delay in the playback, thus providing a much better user experience. The partial contents down-loaded can be a portion of the whole multimedia message, or an muntrelated rich-media message provided by a third party as an advertisement. In this way, the usage of the local storage space on the mobile terminal will be much more efficient.

### BACKGROUND OF THE INVENTION

The invention relates generally to wireless communications technology, and more particularly to method and system for multimedia messaging service.

Mobile terminals such as mobile phones have become a popular means to communicate with other people. Many services are now available on mobile terminals. One of the popular services is the mobile multimedia service (MMS), which includes images, voice, and audio and video contents. This service will enrich person-to-person messaging and pave the way for content-push services. With more and more rich media enabled mobile terminals and network architectures available, on-demand mobile multimedia services will be delivered to users via media streaming and downloading techniques that enrich mobile browsing and content accessing.

Multimedia-enriched services are expected to drive usages, operator revenues and bandwidth consumptions in mobile networks. However, at present, rich media messages are too large for mobile terminals with relatively small user space (typically 2M bytes) to store locally. For example, a two minute MPEG-4 encoded QCIF (Quarter Common Intermediate Format) video played at 10 frames per second (fps) will take roughly 1.5M bytes space. This is unacceptable to most mobile phones in the market because of their small storage space that is shared by different applications.

FIG. 1 shows a MMS reference architecture 10 as defined by 3GPP (Third Generation Partnership Project), which is an organization that develops specifications for a 3G system. In FIG. 1, a MMS relay/server 20 is connected to various elements, including a billing system 32, MMS VAS (value added service) applications 34, MMS user databases 36, a HLR (home location register) 38, and a plurality of external servers 42 to 48 for providing functionalities such as E-mail, fax, SMS, etc. Server 48 is a media server that stores rich-media contents including video. Alternatively, server 48 may be located in MMS relay/server 20 or may be a web server. MMS relay/server 20 is also connected to a “foreign” MMS relay/server 40, which is located in another MMSE (Multimedia Message Service Environment). A MMSE refers to a collection of MMS specific network elements under the control of a single administration and may include more than one MMS relay/server. MMS user agents A, B and C can send multimedia messages to one another via the MMS relays/servers. A MMS user agent refers to an application residing on a mobile terminal (e.g., a user equipment (UE), a mobile station (MS), etc.) or an external device that performs MMS-specific operations on a user's behalf.

FIG. 2 is a flowchart diagram of a multimedia message (MM) delivery process 100. It illustrates how a multimedia message is delivered via streaming in a conventional way. Upon receiving a MMS message notification, the MMS user agent will notify the user of an associated mobile terminal that a new MM has arrived (step 102). If the user chooses to view the MM (step 106), the attachment associated with the MM is parsed (step 112) to determine whether a SDP (Session Description Protocol) file is attached (step 116). A SDP file contains the description of the session (including session name, author, etc.), the type of media to be presented, and the bit rate of the rnedia. If a SDP file is not attached, it may be because the MM contains non-streamable contents such as messages with plain text only. In such a case, the MMS user agent will render the MM immediately. On the other hand, if a SDP file is attached, it will be parsed (step 122). With the parameters from the SDP file, the MMS user agent can connect the mobile terminal to the media server via RTP (Transport Protocol for Real-Time Applications)/RTSP(Real Time Streaming Protocol) protocols (step 126) and receive the contents from the media server via streaming (step 132). At the same time, the MMS user agent can render the MM (step 136).

However, live streaming from a media server in a wireless environment will take considerable amount of time about 8 to 15 seconds for each two minute MPEG-4 QCIF video message. For a larger video message, the user will have to view it in discrete segments because the user has to wait for 8 to 15 seconds for each two minute video segment to arrive. Given the experience of video streaming on the Internet, which usually requires an initial waiting time of 6 to 15 seconds for each video message, regardless of the size of the video message, the delays in a wireless environment will be unacceptably longer and will make the user to wait annoyingly.

Therefore, there is a need for a MMS system that significantly improves a user's experience associated with receiving and viewing MMs.

### SUMMARY OF THE INVENTION

The present invention allows a portion of a multimedia message, usually the beginning part of the message (e.g., the first 10 seconds of the message) to be delivered to and stored on a mobile terminal beforehand. For example, a 10 seconds MPEG-4 encoded QCIF video occupies roughly 80˜120 k space, which is much less than the capacity required for storing the whole message. When a user wants to view the message, the portion of the message stored locally will be played back immediately, while at the same time a user agent residing in the mobile terminal will contact a media server for the remaining contents using the streaming technology. This would give the user an impression that the whole message is stored locally since there is nearly no noticeable delay in the playback, thus providing a much better user experience. The partial contents downloaded can be a portion of the whole multimedia message, or an unrelated rich-media message provided by a third party as an advertisement. In this way, the usage of the local storage space on the mobile terminal will be much more efficient.

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 shows a MMS reference architecture as defined by 3GPP;

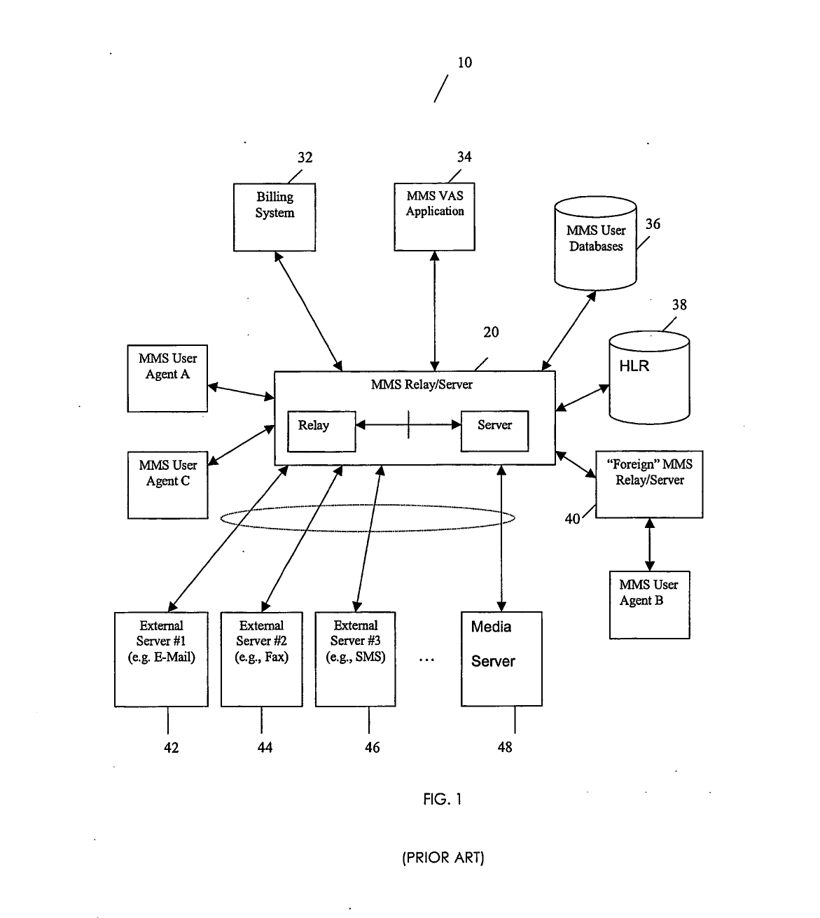

FIG. 2 is a flowchart diagram of a conventional multimedia message delivery process;

FIG. 3 is a flowchart diagram illustrating a process performed by a MMS user agent in connection with receiving and delivering multimedia messages according to a first embodiment of the invention; and

FIG. 4 is a flowchart diagram illustrating a multimedia message delivering process performed by a MMS server according to a second embodiment of the invention.

Throughout the drawings, the same reference numerals indicate similar or corresponding features or functions.

### DETAILED DESCRIPTION OF THE PREFERRED EMBODIMENTS

The present invention allows a portion of a multimedia message (MM), usually the beginning part of the message (e.g., the first 10 seconds of the message), to be delivered to a mobile terminal or user equipment (UE) in advance. For example, a 10 seconds MPEG-4 encoded QCIF video will occupy roughly 80˜20 k space, which is much less than the capacity required for storing the whole message. When a user wants to view the MM, the portion of the message stored locally will be played back immediately, while at the same time the user agent residing in the UE will contact the media server for the remaining contents using the streaming technology defined in the 3GPP standard specification. This would give the user an impression that the whole message is stored locally since there is nearly no noticeable delay in the playback, thus providing a much better user experience. The partial contents downloaded in advance can be a portion of the whole multimedia message, or an unrelated rich-media message provided by a third party as an advertisement.

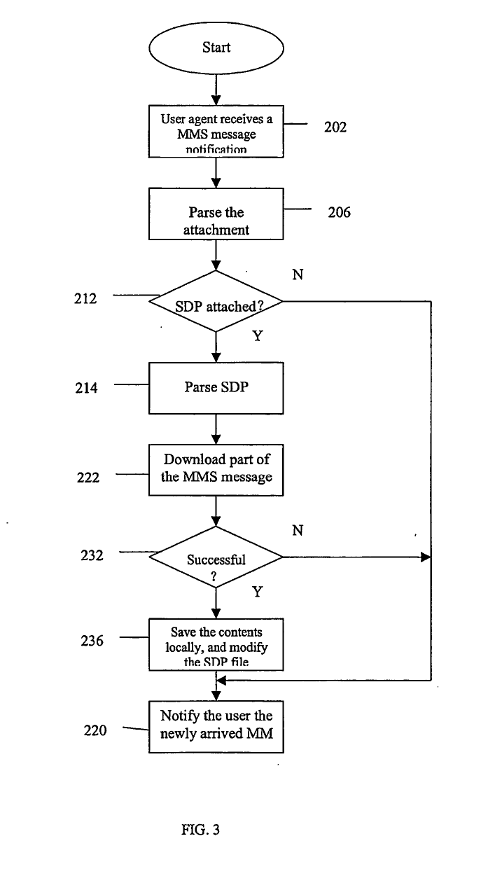

FIG. 3 is a flowchart diagram illustrating a process 200 performed by a MMS user agent residing in a mobile terminal, in connection with receiving and delivering MMs according to a first embodiment of the invention. As illustrated, after the user agent receives a MMS message notification (step 202), it will try to parse the attachment to the message notification (step 206) to determine whether a SDP file is attached (step 212). As described before, the SDP file contains the description of the session (e.g., session name, author, etc.), the type of the media to be presented and the bit rate of the media. If no SDP file is attached because for example, the MM contains non-streamable contents such as text messages only, the user agent will notify the user of the newly arrived MM (step 220) and allow the user to have an option to view the message.

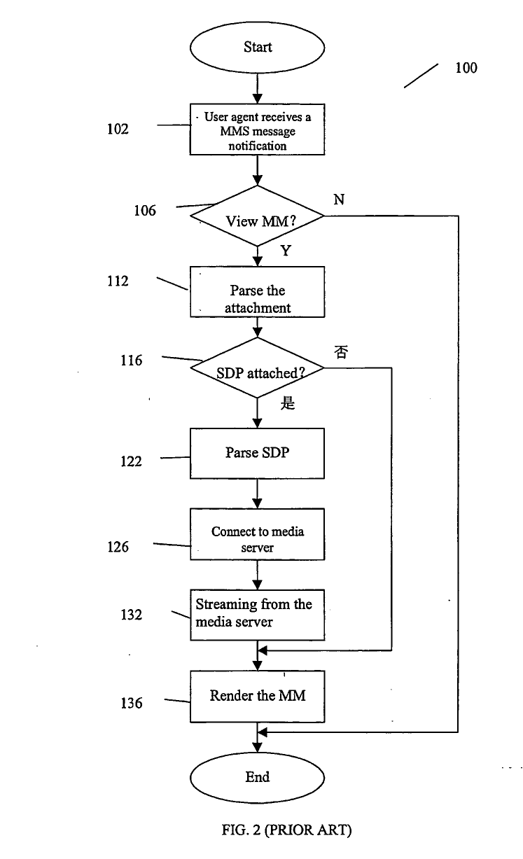

However, if a SDP file is attached and the user agent recognizes that a link to rich media contents is included in the SDP file after parsing the SDP file (step 214), it will try to immediately download, from the media server, a part of the message for a predetermined duration, e.g., 15 seconds, using the RTP protocols (step 222). The user agent may also determine how long the portion of the MM should be pre-fetched by consulting with a database in the mobile terminal that contains information about the network characteristics, mobile terminal capability and user preferences. Then, a determination of whether the download is successful is made (step 232). If the download fails due to, for instance, problems relating to the network or media server, the user agent will notify the user about the newly arrived MM (step 220) and deliver the message in a conventional way such as illustrated in FIG. 2.

On the other hand, if the download is successful and upon receiving the portion of the MM, e.g., 15 seconds of the MM, the user agent will save that received portion locally and modify the SDP file for later use, noting the size of the contents stored locally, where to fetch the remaining portion of the contents, the size of the remaining portion, etc. (step 236). Then the user agent notifies the user that a new MM has just arrived (step 220). If the user wants to view the MM, the user agent will quickly play back the received portion, while at the same time it will try to set up a streaming connection with media server in a conventional manner for the remaining contents of the MM. Under most circumstances, there is a sufficient time to set up the connection with the media server during that period of time in which the received portion of the MM is being played, so that the remaining contents of the MM will become available for the user to view in a seamless manner. In this way, the user will have a quick access to the MM, eliminating the waiting time ranging from 8 to 15 seconds otherwise required for the user to start viewing the MM. The invention also gives the user an impression of viewing the MM locally, and thus easing the impatience of a typical user. If the user finds the contents being played are not interesting, he or she may immediately interrupt the connection without further wasting the time.

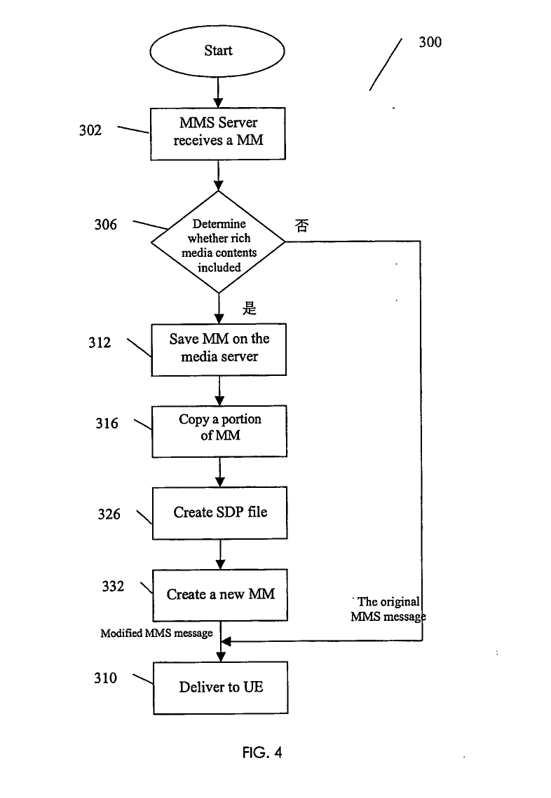

FIG. 4 is a flowchart diagram illustrating a MM delivering process 300 performed by a MMS server (e.g., in MMS relay/server 20) according to a second embodiment of the invention. Upon receiving a MM (step 302), the MMS server will determine whether it contains rich media contents (step 306). If it contains text only, the server will deliver the message directly to the UE without any modification so as to make it immediately available to the user (step 310). Otherwise, the server will need to modify the message. The server will first store the message with rich media contents in a pre-selected location, e.g., a media server (step 312), and copy a portion of the message, e.g., the first 15 seconds (step 316). The server then creates a SDP file that contains the location of the message, the duration of the copied portion of the message, and other information (step 326). Thereafter, the server attaches the SDP file to the copied portion of the original message to create a new MM (step 332). Alternatively, the server may also attach the SDP file to a third party's contents, such as advertisements. The newly created MM will be sent to the user agent (step 310).

Upon receiving the new MM from the MMS server, the user agent will save it in the same way as any downloaded message. When the user tries to view the message, the user agent will first play back the locally stored contents, while at the same time it will try to set up a streaming connection with the media server using the information provided by the attached SDP file. This will allow the remaining contents of the message to be available to the user to view in a seamless way. In this way, a much higher efficiency in the usage of the local storage space on the mobile terminal can be achieved.

As described above, the partially downloaded contents received by the user agent can be a portion of the original MM, or an unrelated rich media message provided by a third party as an advertisement. In the latter case, the third party may allow the user to access the MM at no charge if the user commits to view the attached advertisement in its entirety. In a similar manner, multiple MMs can link to the same locally stored contents, e.g., the same advertisement.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A mobile terminal, comprising:
means for receiving a notification of an incoming multimedia message;
means for determining whether the incoming message contains rich media contents; and
means for downloading a portion of the incoming message having a pre-determined duration for a user to view on the terminal, if the message contains rich media contents.

2. The terminal of claim 1, wherein the determining means includes means for parsing an attachment of the notification to determine whether the message contains rich media contents, the attachment containing information about a media type of the incoming message.

3. The terminal of claim 2, wherein the attachment includes a Session Description Protocol (SDP) file.

4. The terminal of claim 1, further comprising means for displaying the downloaded portion of the incoming message on the terminal, in response to a user's command.

5. The terminal of claim 4, further comprising:
a storage element; and
means for saving the downloaded portion of the incoming message on the storage element.

6. The terminal of claim 1, further comprising means for notifying a user of the incoming message.

7. The terminal of claim 1, further comprising means for accessing the remaining of the incoming message.

8. The terminal of claim 7, wherein the accessing means includes means for modifying an attachment file to the incoming message to indicate a starting point of the incoming message for accessing by the accessing means.

9. The terminal of claim 8, wherein the attachment file includes a Session Description Protocol (SDP) file.

10. The terminal of claim 1,
further comprising means for connecting the terminal to a server storing the incoming message for accessing the remaining of the incoming message;
wherein the pre-determined duration is sufficiently long for the connecting means to connect the terminal to the server so as to allow the user to view the whole incoming message in a continuous manner.

11. A multimedia message service server, comprising:
means for receiving an incoming multimedia message;
means for-determining whether the incoming message contains rich media contents; and
means for delivering a new multimedia message to a receiving mobile terminal, if the incoming message contains rich media contents.

12. The server of claim 11, wherein the new multimedia message includes a portion of the incoming message having a pre-determined duration.

13. The server of claim 11, wherein the new multimedia message includes an advertisement having a pre-determined duration.

14. The server of claim 11, further comprising means for creating an attachment file to the new multimedia message, indicating where the incoming message may be accessed.

15. The server of claim 14, wherein the attachment file includes a Session Description Protocol (SDP) file.

16. The server of claim 11, further comprising means for creating the new multimedia message.

17. The server of claim 16, further comprising:
means for saving the incoming message in a pre-selected location; and
means for copying a portion of the incoming message for including in the new multimedia message.

18. The server of claim 17, wherein the pre-selected location is in a storage element of a media server.

19. The server of claim 12, wherein the pre-determined duration is sufficiently long for the receiving mobile terminal to connect to a server storing the incoming message so as to allow the user to view the whole incoming message on the terminal in a continuous manner.

20. The server of claim 13, wherein the pre-determined duration is as long as is substantially required for the receiving mobile terminal to connect to a server storing the incoming message so as to allow the user to view the whole incoming message on the terminal in a substantially continuous manner.

21. A method performed at a mobile terminal, comprising the steps of:
receiving a notification of an incoming multimedia message;
determining whether the incoming message contains rich media contents; and
downloading a portion of the incoming message having a pre-determined duration for a user to view on the terminal, if the message contains rich media contents.

22. The method of claim 21, wherein the step of determining includes a step of parsing an attachment of the notification to determine whether the message contains rich media contents, the attachment containing information about a media type of the incoming message.

23. The method of claim 22, wherein the attachment includes a Session Description Protocol (SDP) file.

24. The method of claim 21, further comprising a step of displaying the downloaded portion of the incoming message on the terminal, in response to a user's command.

25. The method of claim 24, further comprising a step of saving the downloaded portion of the incoming message on a storage element of the terminal.

26. The method of claim 21, further comprising a step of notifying a user of the incoming message.

27. The method of claim 21, further comprising a step of accessing the remaining of the incoming message.

28. The method of claim 27, further comprising a step of modifying an attachment file to the incoming message to indicate the starting point of the incoming message for accessinig.

29. The method of claim 28, wherein the attachment file includes a Session Description Protocol (SDP) file.

30. The method of claim 21,
further comprising a step of connecting the terminal to a server storing the incoming message for accessing the remaining of the incoming message;
wherein the pre-determined duration is sufficiently long for connecting the terminal to the server so as to allow the user to view the whole incoming message on the terminal in a continuous manner.

31. A method performed at a multimedia message service server, comprising the steps of:
receiving an incoming multimedia message;
determining whether the incoming message contains rich media contents; and
delivering a new multimedia message to a receiving mobile terminal, if the incoming message contains rich media contents.

32. The method of claim 31, wherein the new multimedia message includes a portion of the incoming message having a pre-determined duration.

33. The method of claim 31, wherein the new multimedia message includes an advertisement.

34. The method of claim 31, further comprising a step of creating an attachment file to the new multimedia message, indicating where the incoming message may be accessed.

35. The method of claim 34, wherein the attachment file includes a Session Description Protocol (SDP) file.

36. The method of claim 31, further comprising a step of creating the new multimedia message.

37. The method of claim 36, further comprising the steps of:
saving the incoming message in a pre-selected location; and
copying a portion of the incoming message for including in the new multimedia message.

38. The method of claim 37, wherein the pre-selected location is in a storage element of a media server.

39. The method of claim 32, wherein the pre-determined duration is sufficiently long for the receiving mobile terminal to connect to a server storing the incoming message so as to allow the user to view the whole incoming message on the terminal in a continuous manner.

40. The method of claim 33, wherein the pre-determined duration is as long as is substantially required for the receiving mobile terminal to connect to a server storing the incoming message so as to allow the user to view the whole incoming message on the terminal in a substantially continuous manner.
